(19) United States
(12) Patent Application Publication
(10) Pub. No.: US 2014/0195943 A1
(43) Pub. Date: Jul. 10, 2014

(54) USER INTERFACE CONTROLS FOR PORTABLE DEVICES

(71) Applicant: PATENT CATEGORY CORP., Walnut, CA (US)

(72) Inventors: Yu Zheng, Walnut, CA (US); Felix Sui, Irvine, CA (US); Hank Hang Li, Alhambra, CA (US)

(73) Assignee: PATENT CATEGORY CORP., Walnut, CA (US)

(21) Appl. No.: 13/734,149

(22) Filed: Jan. 4, 2013

(51) Int. Cl. G06F 3/048

(52) U.S. Cl. CPC G06F 3/048
USPC 715/768

(57) ABSTRACT

A method of controlling an electronic device with a touch-sensitive display that has a graphical user interface (GUI) with a primary display and a translucent layer. The method includes displaying the primary display which contains the graphical objects for normal operation, while the primary display is being displayed, activating the translucent layer to display a control arrow arrangement, manipulating the control arrow arrangement to adjust a parameter associated with the GUI or the electronic device, and de-activating the translucent layer to cause the primary display to be displayed again.

### BACKGROUND OF THE INVENTION

1. Field of the Invention

The present invention is directed to portable electronic devices, and in particular, to user interfaces and the control of operation on user interfaces.

2. Description of the Prior Art

As portable devices become more complex, and the amount of information to be processed and stored increases, it has become a significant challenge to design a user interface that allows users to easily interact with the device. This is unfortunate because the user interface is the gateway through which users receive not only content but also responses to user actions or behaviors, including user attempts to access a device's features or tools. Some portable electronic devices (e.g., mobile phones) have resorted to adding more pushbuttons, overloading the functions of pushbuttons, or using complex menu systems to allow a user to access, store and manipulate data. These conventional interfaces often result in complex key sequences and menu hierarchies that must be memorized by the user. Indeed, some key sequences are so complex as to require two hands to complete. However, this is not optimal for some time of portable electronic devices, such as mobile phones, since they are usually operated most efficiently using one hand.

Accordingly, there is a need for simpler, more intuitive user interfaces for portable devices that will enable a user to conveniently access, store and manipulate graphical objects and data without memorizing key sequences or menu hierarchies.

There is also a need for user interfaces for portable devices that can be conveniently operated by using one hand.

### SUMMARY OF THE DISCLOSURE

To accomplish the objectives set forth above, the present invention provides a method of controlling an electronic device with a touch-sensitive display that has a graphical user interface (GUI) with a primary display and a translucent layer. The method includes displaying the primary display which contains the graphical objects for normal operation, while the primary display is being displayed, activating the translucent layer to display a control arrow arrangement, manipulating the control arrow arrangement to adjust a parameter associated with the GUI or the electronic device, and de-activating the translucent layer to cause the primary display to be displayed again.

### BRIEF DESCRIPTION OF THE DRAWINGS

FIGS. 1A-1G illustrate one embodiment of a user interface for a portable electronic device according to the present invention.

FIG. 2 is a flow diagram illustrating one manner in which the embodiment of FIGS. 1A-1G can be operated.

FIGS. 3A-3G illustrate another embodiment of a user interface for a portable electronic device according to the present invention.

FIG. 4 is a flow diagram illustrating one manner in which the embodiment of FIGS. 3A-3G can be operated.

FIGS. 5A-5G illustrate yet another embodiment of a user interface for a portable electronic device according to the present invention.

FIG. 6 is a flow diagram illustrating one manner in which the embodiment of FIGS. 5A-5G can be operated.

FIGS. 7A-7G illustrate a further embodiment of a user interface for a portable electronic device according to the present invention.

FIG. 8 is a flow diagram illustrating one manner in which the embodiment of FIGS. 7A-7G can be operated.

FIG. 9 is a flow diagram illustrating how the translucent layer can be made to appear and disappear.

FIGS. 10A-10F illustrate how the mode can be changed.

FIGS. 11A-110 illustrate how the free-hand icon can be moved to a different location.

FIGS. 12A-12C illustrate how the control arrow arrangement can be moved to a different location.

FIG. 13 is a block diagram of one embodiment of portable electronic device architecture for the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

Overview

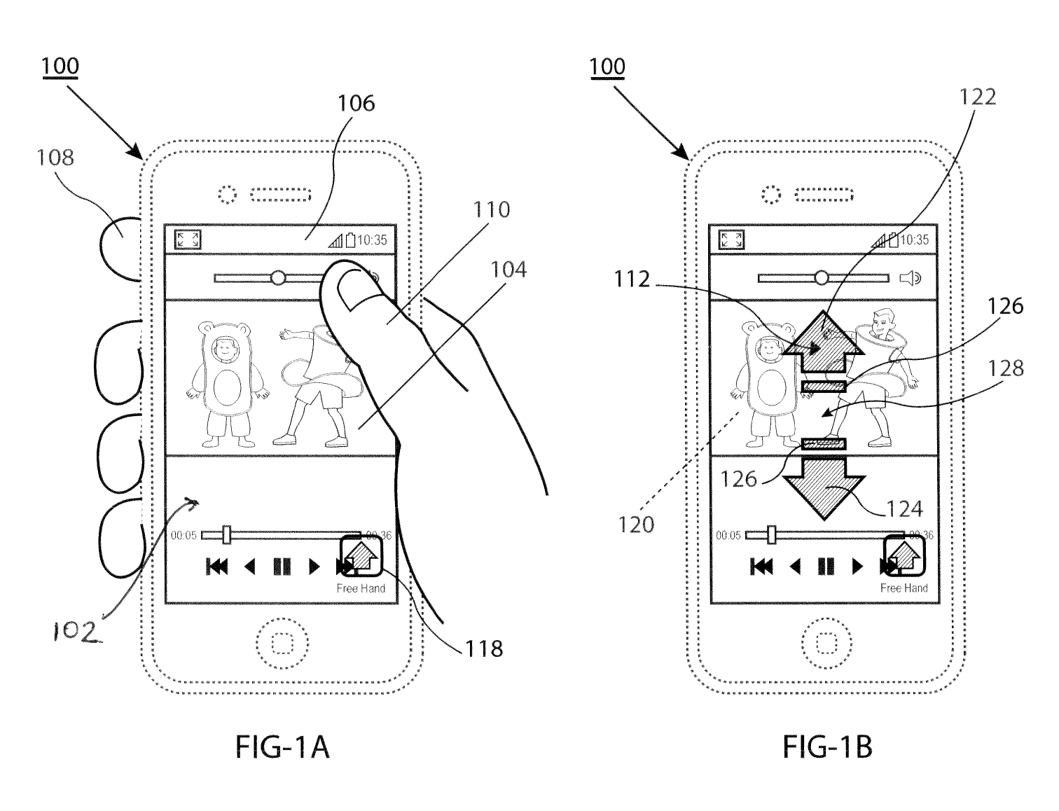

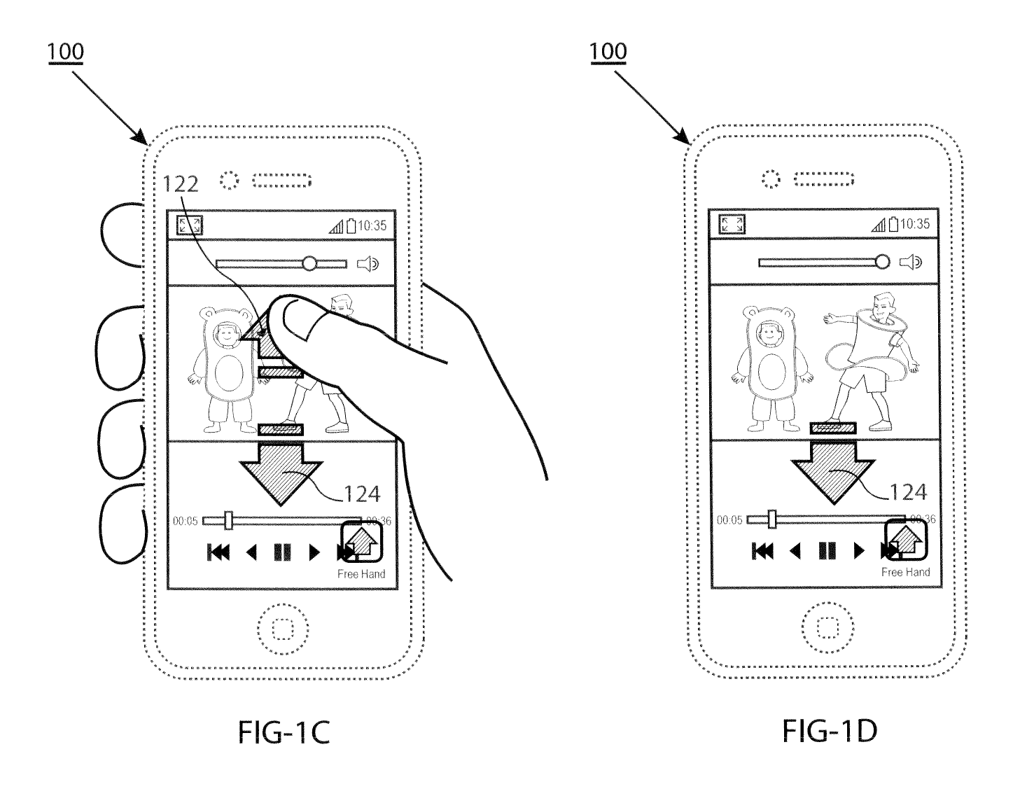

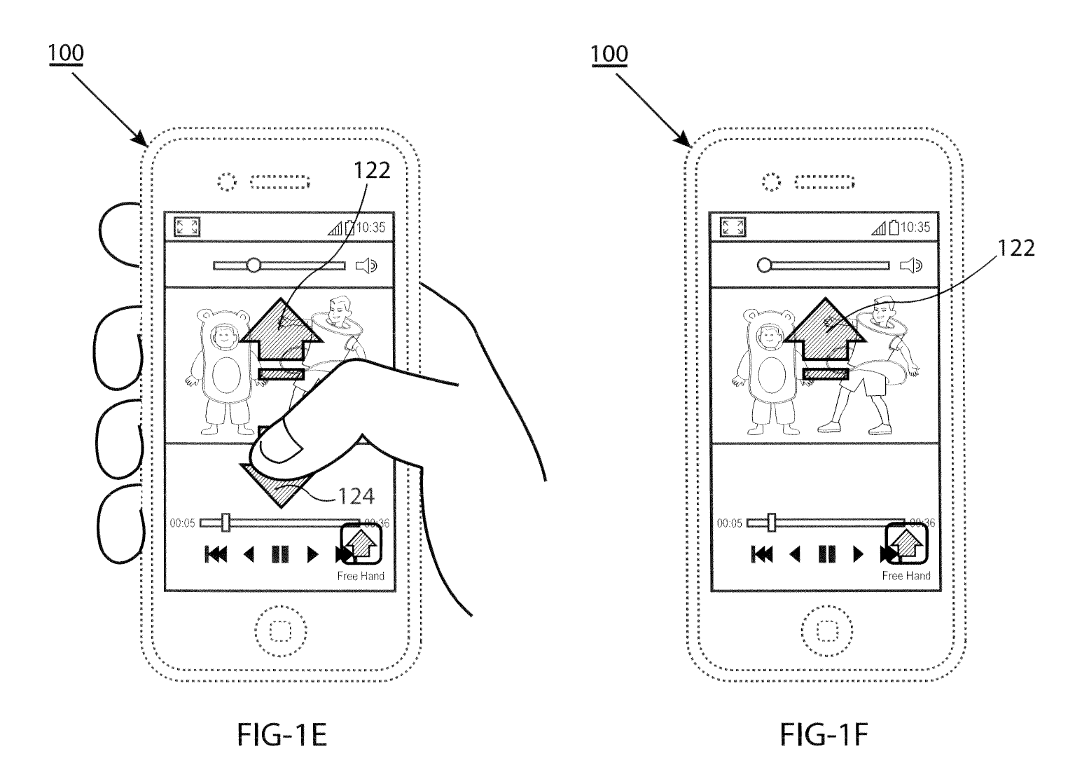

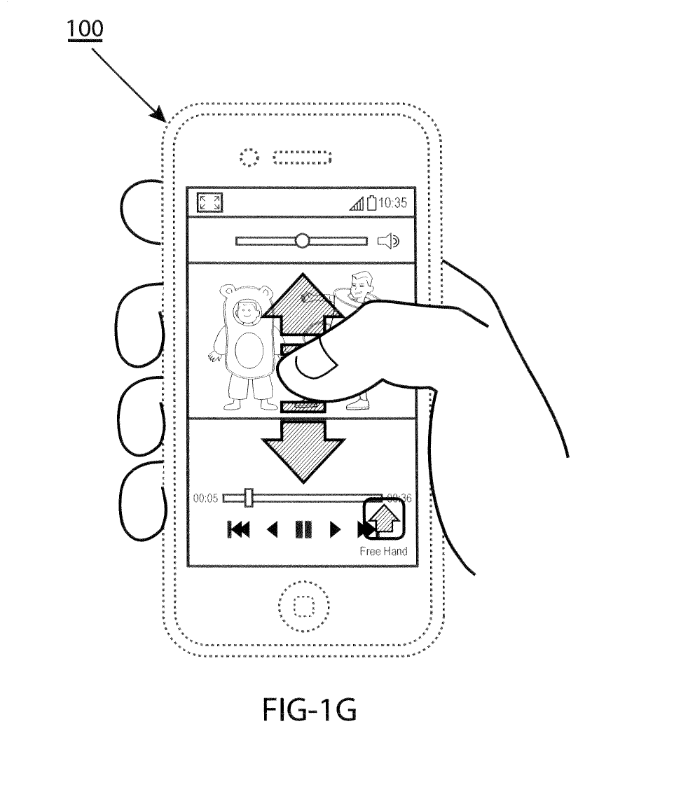

FIG. 1A is an illustration of one embodiment of a portable electronic device 100 according to the present invention. The device 100 includes a multi-touch-sensitive display (e.g., the touch screen 1326 described hereinbelow) with a graphical user interface (GUI) 102. The display surface is transparent to allow various graphical objects to be displayed to the user (e.g., Web pages). In some embodiments, the GUI 102 can be divided into multiple sections or windows. For example, the GUI 102 can include a section 106 for holding graphical indicators representing frequently used features (e.g., battery level, time, and other controls). The GUI 102 can also include a window 104 for manipulating graphical objects, displaying and operating on Web pages, reading messages, text or data, viewing video images, and entering information. Various displays can be presented and changed in the GUI 102 by pressing a menu button. In mobile phone embodiments, dedicated graphical objects can be presented in the GUI 102 representing traditional voice and data service operations (e.g., hold, clear, etc.).

A user can manipulate one or more graphical objects (e.g., an icon, a window, etc.) in the GUI 102 using various finger gestures. As used herein, a gesture is a motion of the object/appendage making contact with the touch screen display surface. For example, a simple tap by a finger can be a gesture. In addition, one or more fingers can be used to perform two-dimensional or three-dimensional operations on one or more graphical objects presented in the GUI 102, including but not limited to magnifying, zooming, expanding, minimizing, resizing, rotating, sliding, opening, closing, focusing, flipping, reordering, activating, deactivating and any other operation that can be performed on a graphical object. In some embodiments, the gestures initiate operations that are related to the gesture in an intuitive manner. For example, a user can place an index finger 108 and thumb 110 (not drawn to scale in the figure) on the sides, edges or corners of the graphical object and perform a pinching or anti-pinching gesture by moving the index finger 108 and thumb 110 together or apart, respectively. The operation initiated by such a gesture results in the dimensions of the graphical object changing. In some embodiments, a pinching gesture will cause the size of the graphical object to decrease in the dimension being pinched. In some embodiments, a pinching gesture will cause the size of the graphical object to decrease proportionally in all dimensions. In some embodiments, an anti-pinching or de-pinching movement will cause the size of the graphical object to increase in the dimension being anti-pinched.

It should be apparent, that any number and/or combination of fingers can be used to manipulate a graphical object, and the disclosed embodiment is not limited to any particular number or combination. For example, in some embodiments the user can magnify an object by placing multiple fingers in contact with the display surface of the GUI 102 and spreading the fingers outward in all directions. In other embodiments, a user can expand or minimize an object by grabbing the corners, sides or edges of the object and performing a de-pinching or pinching action. In some embodiments, the user can focus on or magnify a particular object or a portion of an object by tapping one or more fingers on the display surface of the GUI 102.

In some embodiments, a contact occurs when the user makes direct contact with the graphical object to be manipulated. In other embodiments, a contact occurs when the user makes contact in the proximity of the graphical object to be manipulated. The latter technique is similar to “hot spots” used with Web pages and other computer user interfaces.

Notwithstanding the above, the present invention is particularly suited for use with one hand, and even one finger, thereby making its application particularly suitable for use with mobile phones or any portable electronic devices that are most efficiently operated by using one hand or one finger.

The GUI 102 also provides for two layers of display, where a first translucent layer is above a second underlying layer 120. The translucent layer is the “active” layer where the user is allowed to select icons or manipulate control elements, with the underlying layer being inoperable. As shown in FIG. 1B, the translucent layer is represented by the control arrow arrangement 112, with the underlying layer being the primary display for the GUI 102. In FIG. 1A, the primary display is the active layer during normal use, and there is no translucent layer. The GUI 102 provides the user with two methods to bring out the translucent layer, and to make the translucent layer disappear.

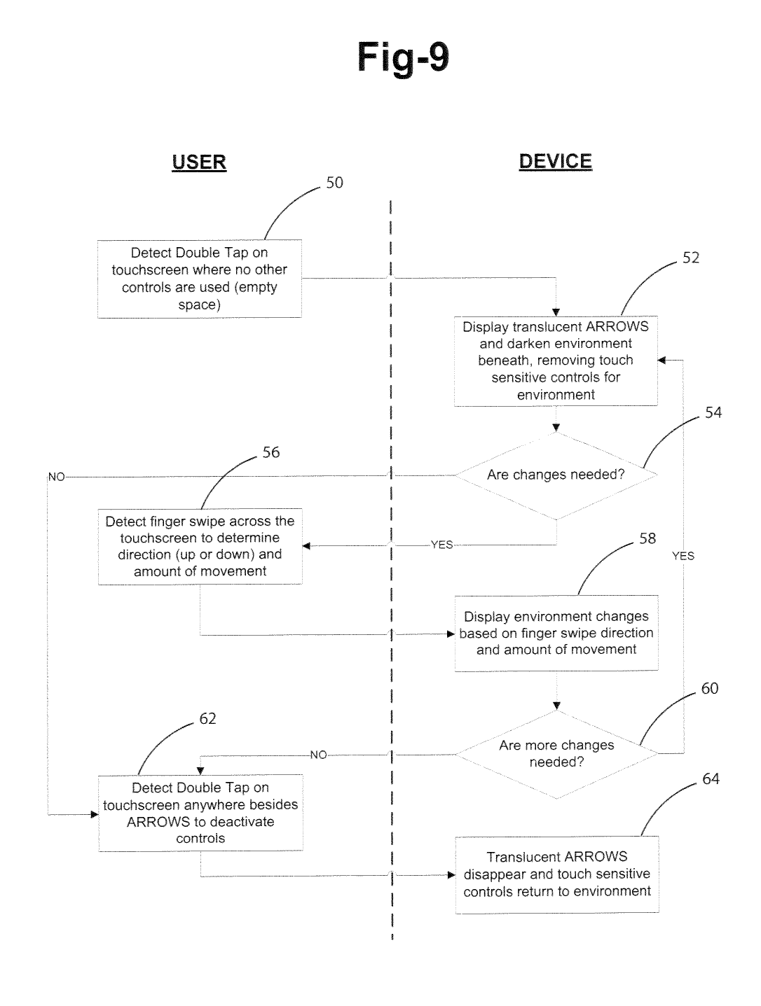

In the first method, when the GUI 102 is in its primary display, the user can tap an empty area of the display twice, and the translucent layer will appear (see FIG. 1B), with the arrow arrangement 112 positioned in the middle of the screen. FIG. 9 is a flow diagram illustrating this operation. In summary, the GUI 102 normally displays the primary display without any underlying layer, as shown in FIG. 1A. When the user wishes to adjust a parameter (as described below), the user taps an empty area of the display twice (step 50), and the GUI 102 will display the control arrow arrangement (step 52). The GUI 102 next detects if changes to the desired parameter are needed (step 54), and if yes, the GUI 102 will detect any finger movement across the display to determine the direction of the movement and the amount of the movement (step 56). The changes based on the movement are displayed on the GUI 102 (step 58). If additional changes are needed (step 60), processing returns to step 52, otherwise the GUI 102 detects another two taps on an empty area of the display (step 62) to deactivate the translucent layer, at which time the translucent layer disappears (step 64) and the primary display is back in normal use. From step 54, if no changes are needed, then processing proceeds to step 62 where the GUI 102 detects another two taps on an empty area of the display to deactivate the translucent layer.

The flow diagram of FIG. 9 shows the detection of finger movement (e.g., swipes) at step 56, but it is also possible for the GUI 102 to detect finger taps on the up arrow 122 or the down arrow 124 at step 56.

In the second method, when the GUI 102 is in its primary display, the user can tap a specific “free-hand” icon 118 (see FIG. 1A), and the translucent layer will appear (see FIG. 1B), with the arrow arrangement 112 positioned in the middle of the screen. The process is the same as shown in the flow diagram of FIG. 9, except that, in step 50, the GUI 102 will detect the presence of a tap on the free-hand icon 118, and in step 62, the GUI 102 will detect the presence of a tap on the free-hand icon 118 which is also found on the translucent layer.

Parameter Adjustment

The present invention provides embodiments directed to the control of various parameters through the use of a control device provided on a separate layer from the layer where the primary display is normally positioned. The control device can be embodied by control arrow arrangement 112.

FIGS. 1A-1G illustrate one embodiment for controlling one or more parameters in an application, such as a volume control for a portable electronic device. A graphical object in the form of control arrow arrangement 112 is provided on a separate translucent layer from the underlying layer 120, which in the present invention, happens to be the layer where the primary display (with the regular icons, image displays and other control elements) is located. The control arrow arrangement 112 includes an up arrow 122, a down arrow 124, and a plurality of bars 126 positioned between the arrows 122 and 124, with a space 128 in the middle between the bars 126.

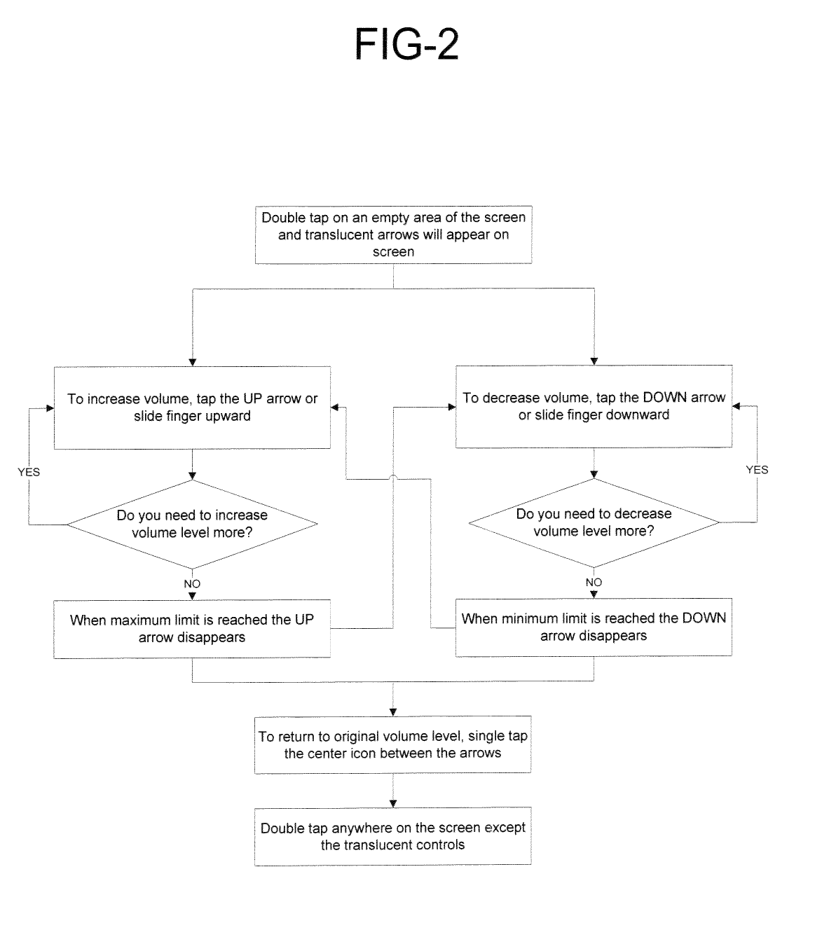

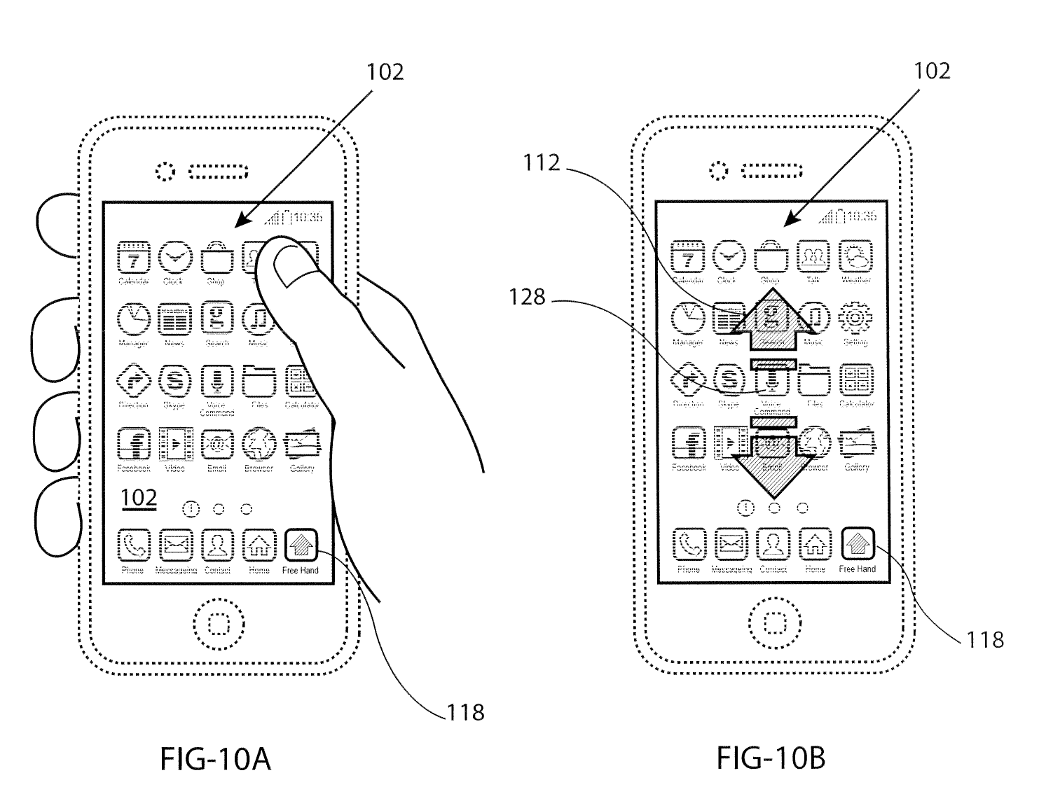

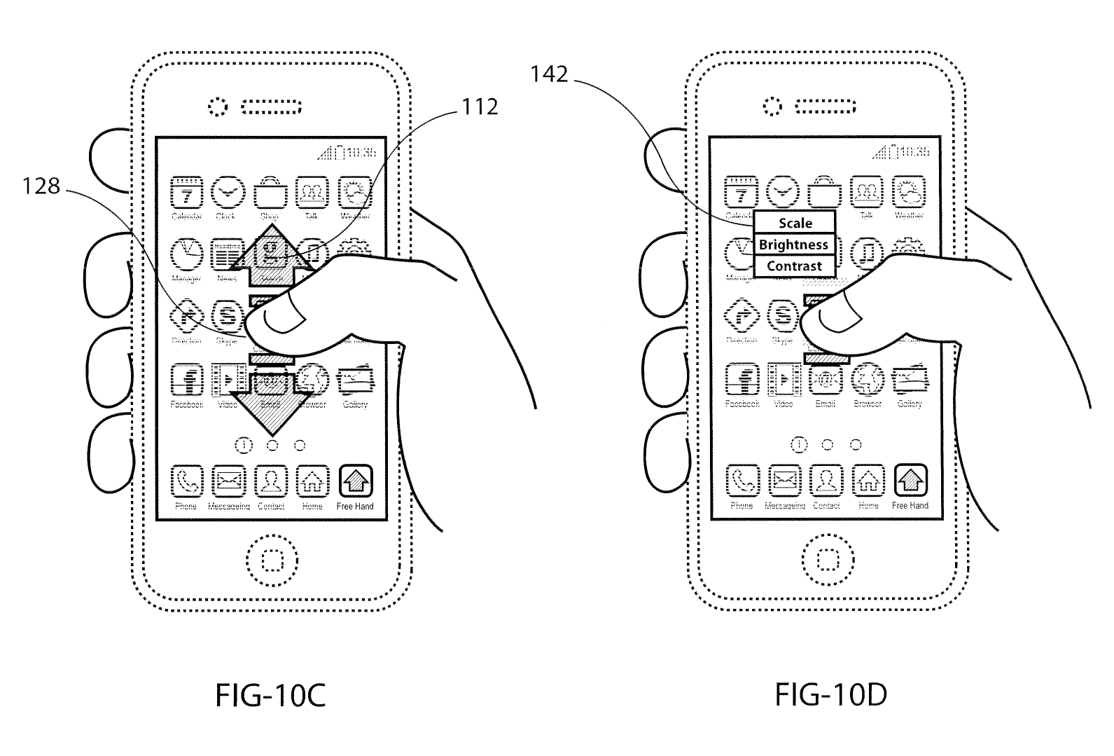

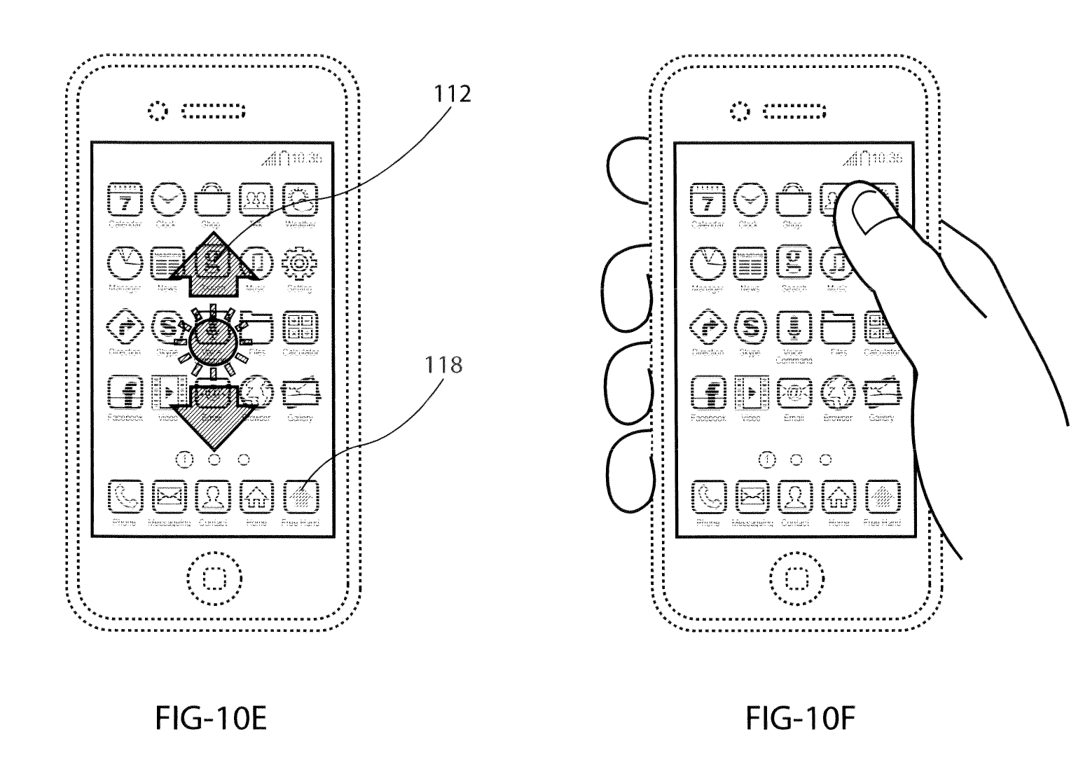

In FIG. 1A, the user is shown as operating the portable electronic device 100 with the primary display for the GUI 102. In FIG. 1A, the user is free to manipulate any of the icons and graphical objects on the primary display. When the user wishes to adjust the volume, the user activates the translucent layer through one of the two methods described above (e.g., taps an empty area of the display twice, or taps on a free-hand icon 118), and the translucent layer will appear (see FIG. 1B), with the arrow arrangement 112 positioned in the middle of the screen. To increase the volume, the user taps on the up arrow 122, or slides a finger (e.g., thumb 110) upwardly (see FIG. 10). When the highest volume is reached, the up arrow 122 disappears from the translucent layer (see FIG. 1D). Similarly, to decrease the volume, the user taps on the down arrow 124, or slides a finger (e.g., thumb 110) downwardly (see FIG. 1E). When the lowest volume is reached, the down arrow 124 disappears from the translucent layer (see FIG. 1F). To bring the volume back to the original setting, the user taps on the space 128 between the bars 126 (see FIG. 1G). Finally, to return to the primary display for the GUI 102, the user taps twice on an empty area of the translucent layer, or taps on the free-hand icon 118. This process (using the double-tap method) is illustrated in the flow chart of FIG. 2.

In this regard, it is noted that the double-tap and free-hand icon 118 options do not appear at the same time. These are merely two different options for bringing out the translucent layer (as described above), and the GUI 102 will be equipped with one but not both of the two options.

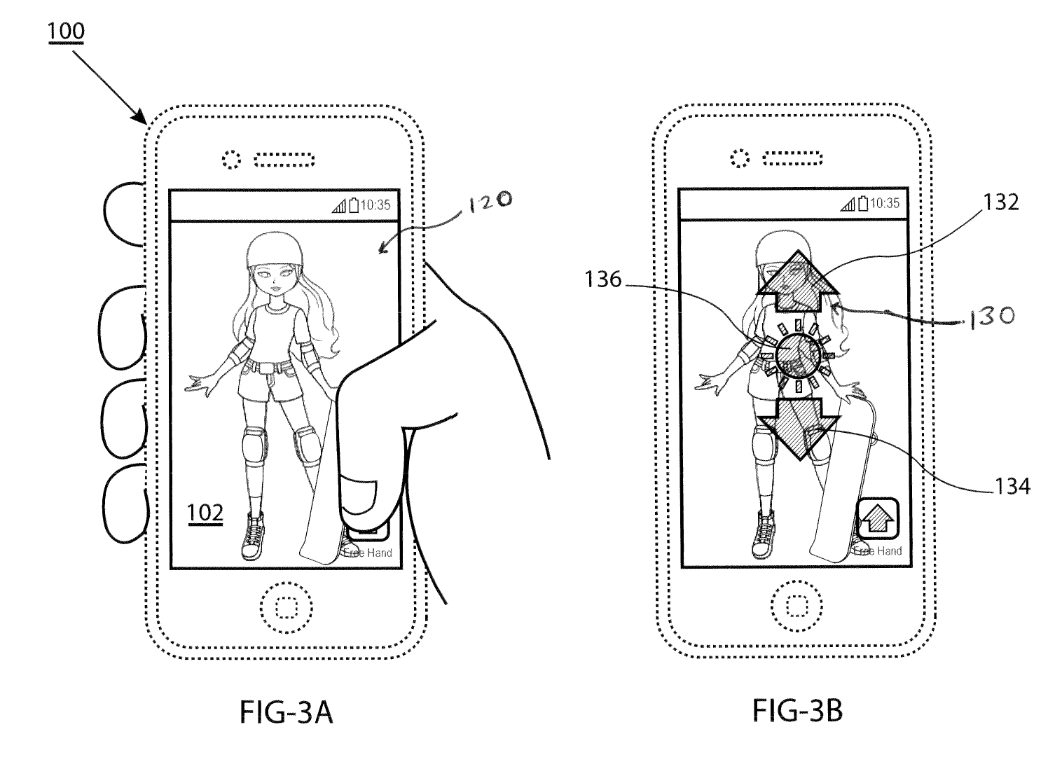

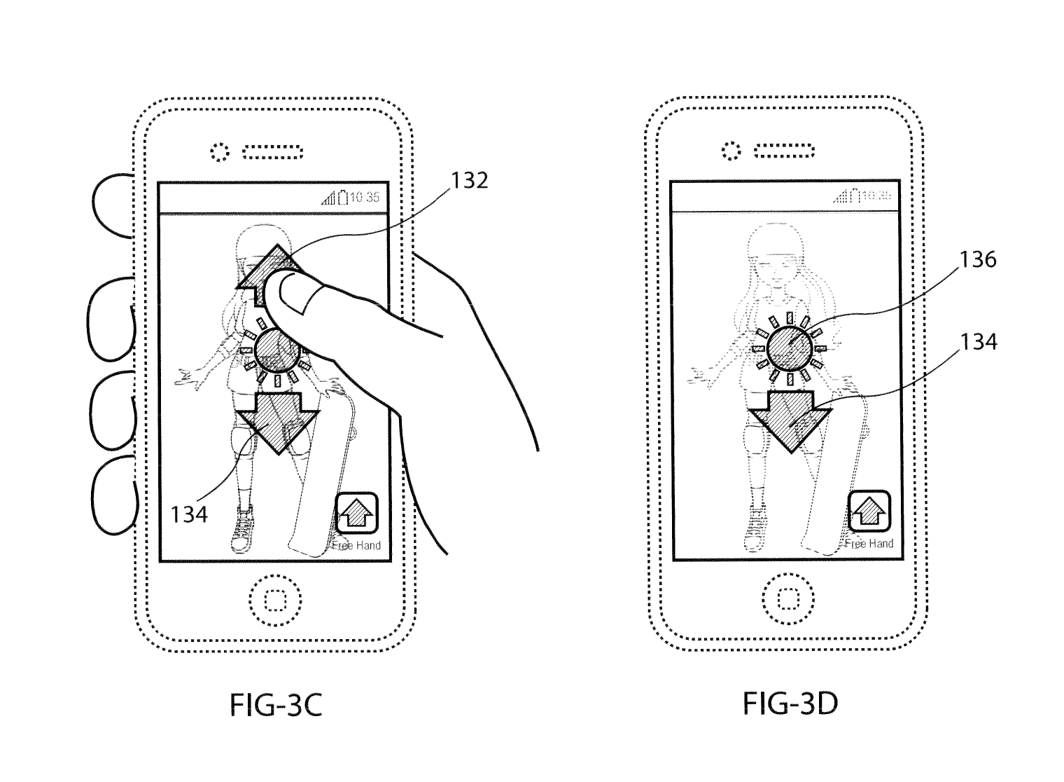

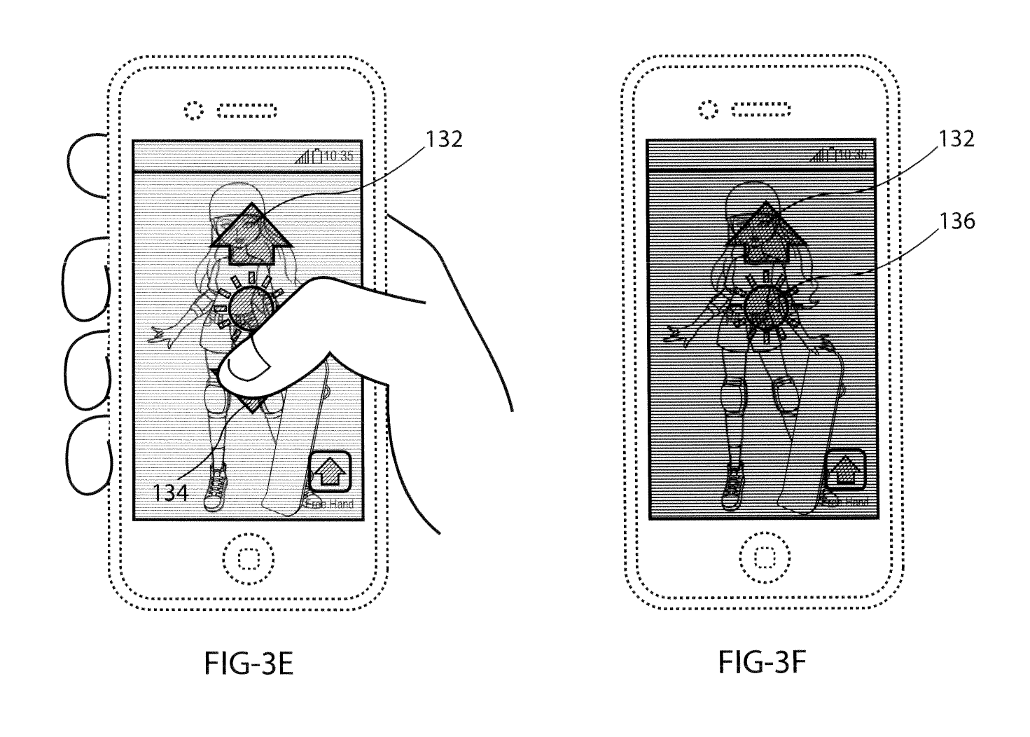

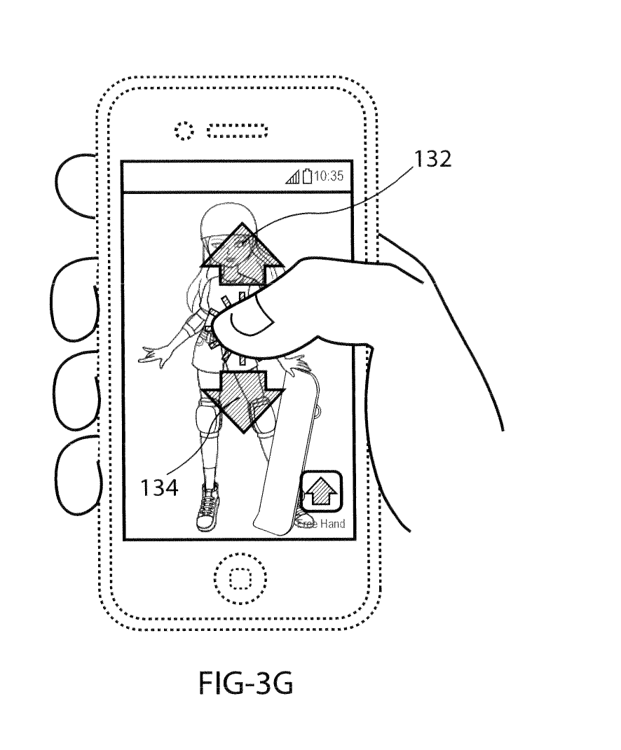

FIGS. 3A-3G illustrate another embodiment for controlling one or more parameters in an application, such as a brightness control for a portable electronic device. A graphical object in the form of control arrow arrangement 130 is provided on a separate translucent layer from the underlying layer 120, which in the present invention, happens to be the layer where the primary display (with the regular icons, image displays and other control elements) is located. The control arrow arrangement 130 includes an up arrow 132, a down arrow 134, and a graphical mode object 136 (e.g., a symbol of the sun) in the middle between the arrows 132 and 134.

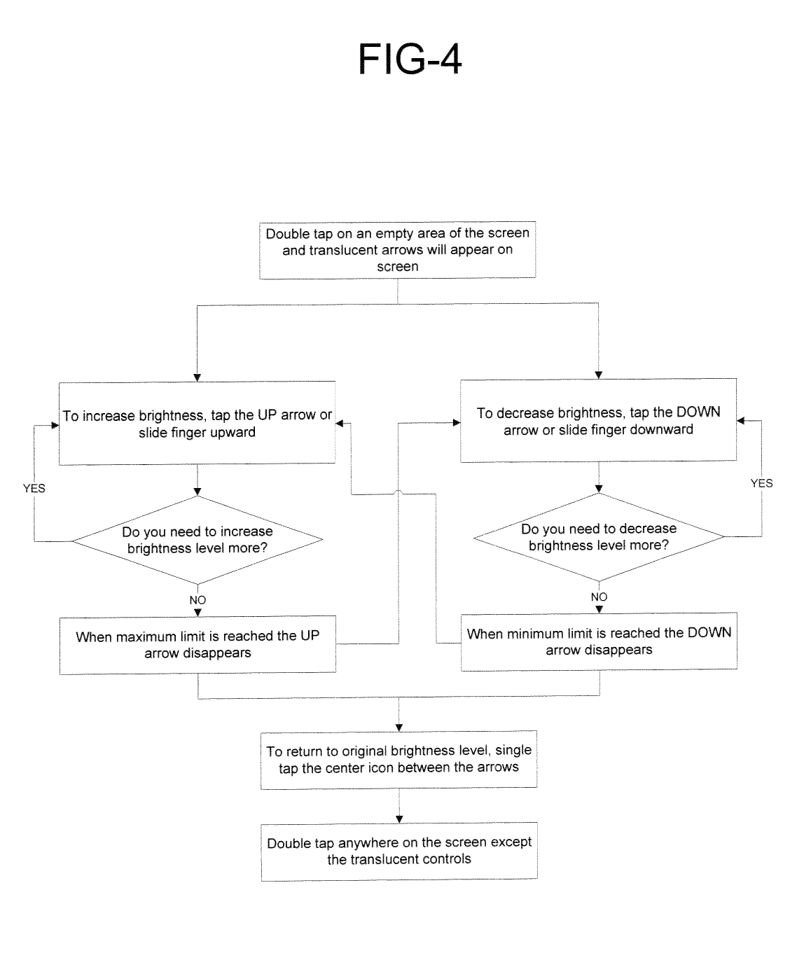

In FIG. 3A, the user is shown as operating the portable electronic device 100 with the primary display for the GUI 102. In FIG. 3A, the user is free to manipulate any of the icons and graphical objects on the primary display. When the user wishes to adjust the brightness, the user either taps an empty area of the display twice or taps on the free-hand icon 118, and the translucent layer will appear (see FIG. 3B), with the arrow arrangement 130 positioned in the middle of the screen. To increase the brightness, the user taps on the up arrow 132, or slides a finger (e.g., thumb) upwardly (see FIG. 3C). When the maximum brightness is reached, the up arrow 132 disappears from the translucent layer (see FIG. 3D). Similarly, to reduce the brightness, the user taps on the down arrow 134, or slides a finger (e.g., thumb) downwardly (see FIG. 3E). When the minimum brightness is reached, the down arrow 134 disappears from the translucent layer (see FIG. 3F). To bring the brightness back to the original setting, the user taps on the object 136 between the arrows 132, 134 (see FIG. 3G). Finally, to return to the primary display for the GUI 102, the user taps twice on an empty area of the translucent layer, or taps on the free-hand icon 118. This process (using the double-tap method) is illustrated in the flow chart of FIG. 4.

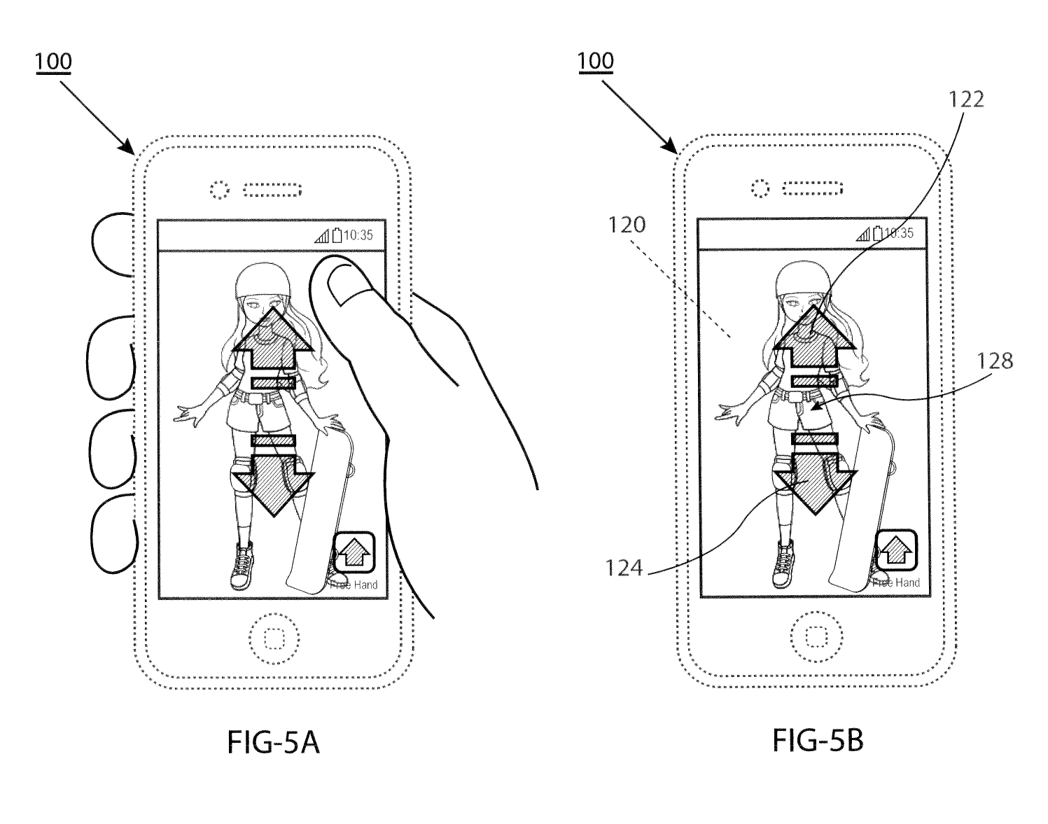

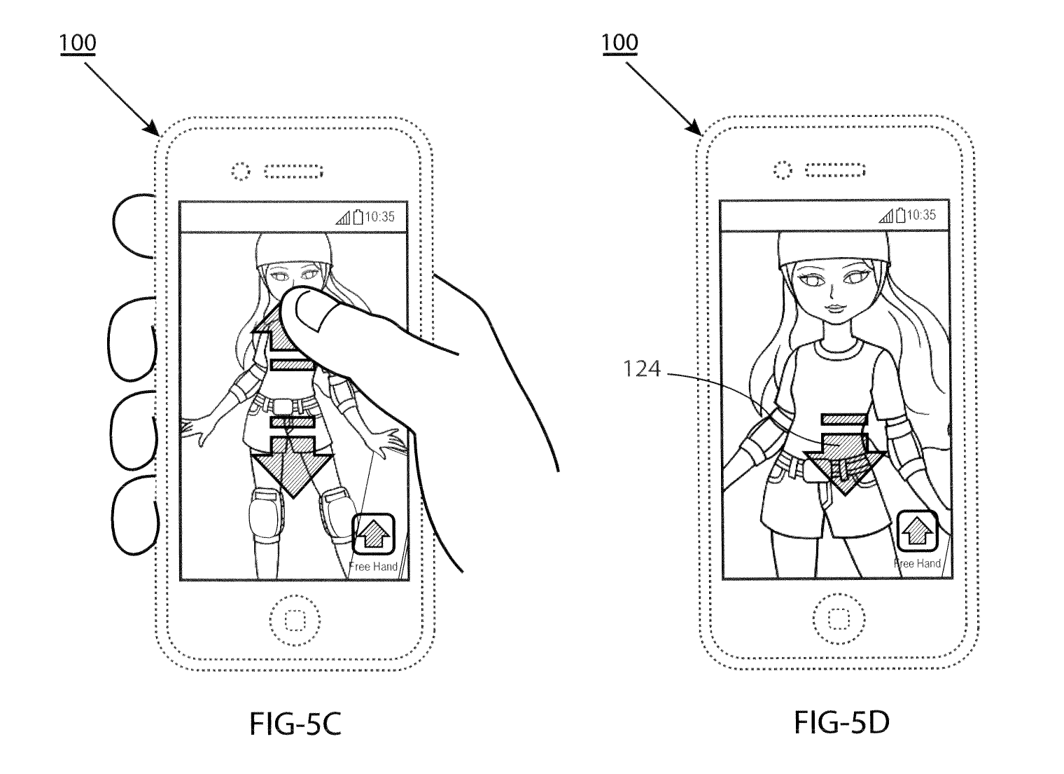

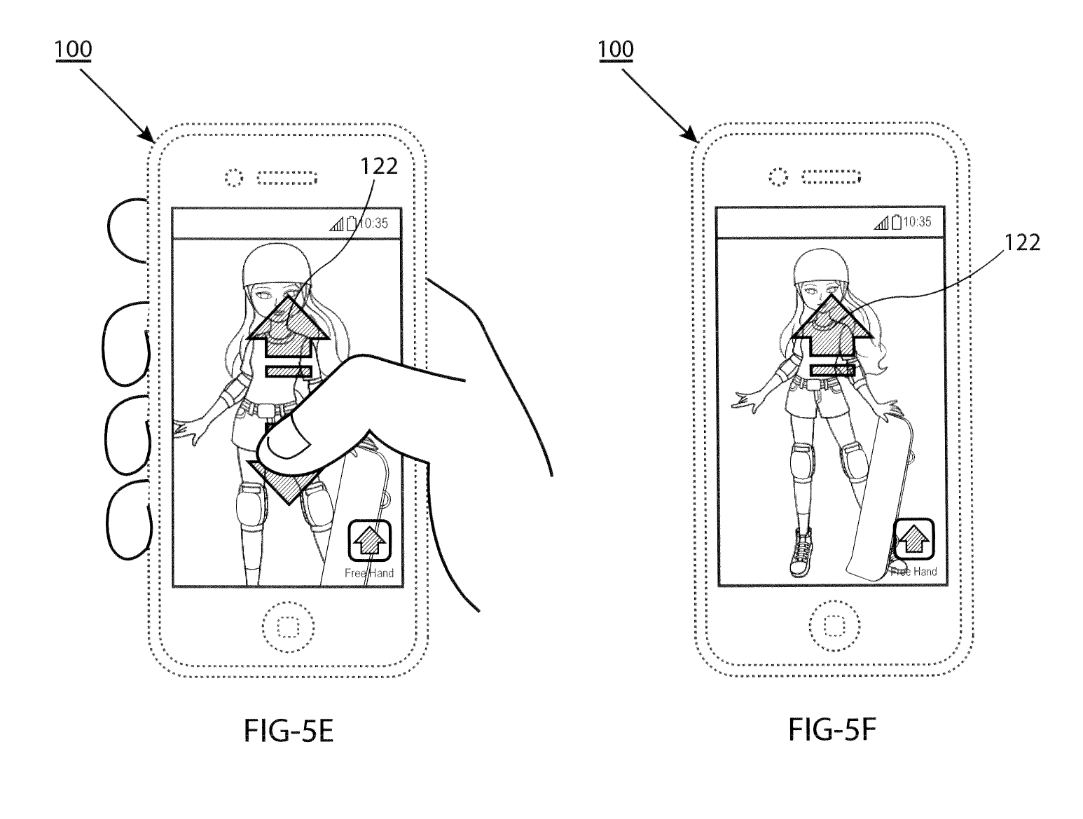

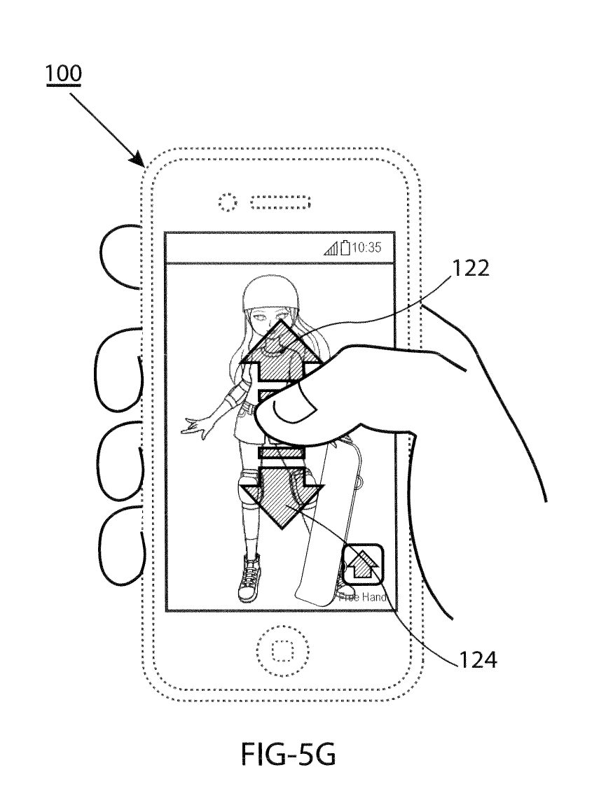

FIGS. 5A-5G illustrate yet another embodiment for controlling one or more parameters in an application, such as image size control for a portable electronic device. The control arrow arrangement 112 of FIGS. 1A-1G is provided on a separate translucent layer from the underlying layer 120.

In FIG. 5A, the user is shown as operating the portable electronic device 100 with the primary display for the GUI 102. In FIG. 5A, the user is free to manipulate any of the icons and graphical objects on the primary display. When the user wishes to adjust the size of the image (e.g., when a photo, video or other image is being displayed on the GUI 102), the user taps an empty area of the display twice, and the translucent layer will appear (see FIG. 5B), with the arrow arrangement 112 positioned in the middle of the screen. To increase the size, the user taps on the up arrow 122, or slides a finger (e.g., thumb) upwardly (see FIG. 5C). When the maximum size is reached, the up arrow 122 disappears from the translucent layer (see FIG. 5D). Similarly, to decrease the size, the user taps on the down arrow 124, or slides a finger (e.g., thumb) downwardly (see FIG. 5E). When the minimum size is reached, the down arrow 124 disappears from the translucent layer (see FIG. 5F).

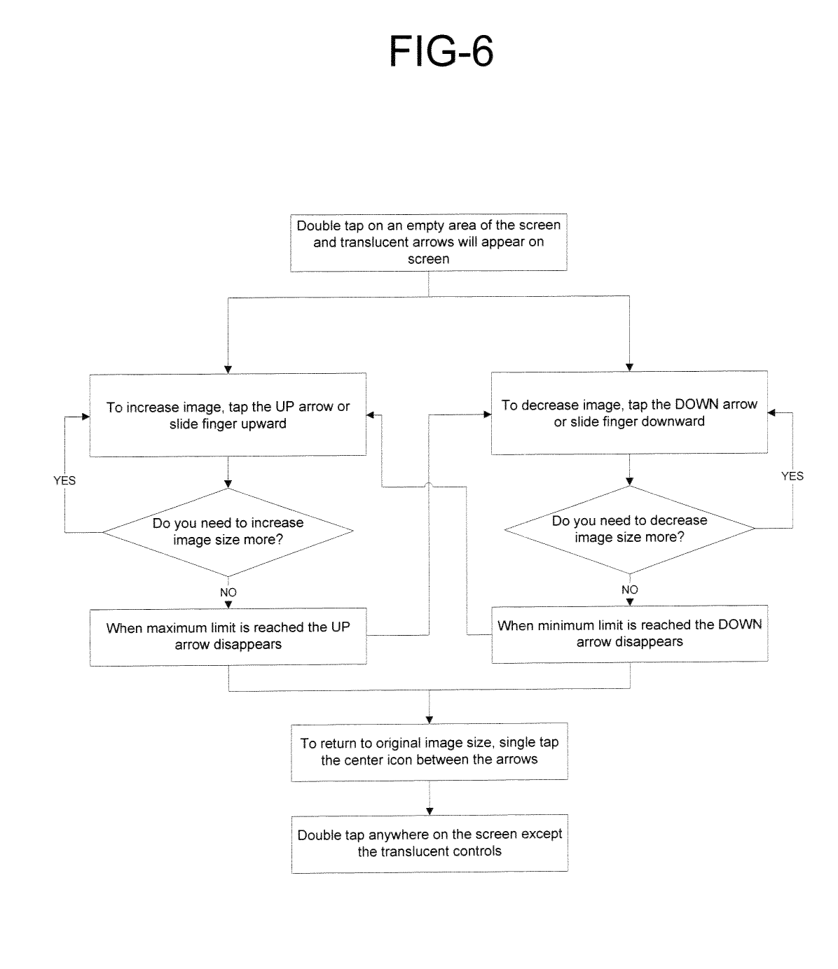

To bring the size back to the original setting, the user taps on the space 128 between the bars 126 (see FIG. 5G). Finally, to return to the primary display for the GUI 102, the user taps twice on an empty area of the translucent layer, or taps on the free-hand icon 118. This process (using the double-tap method) is illustrated in the flow chart of FIG. 6.

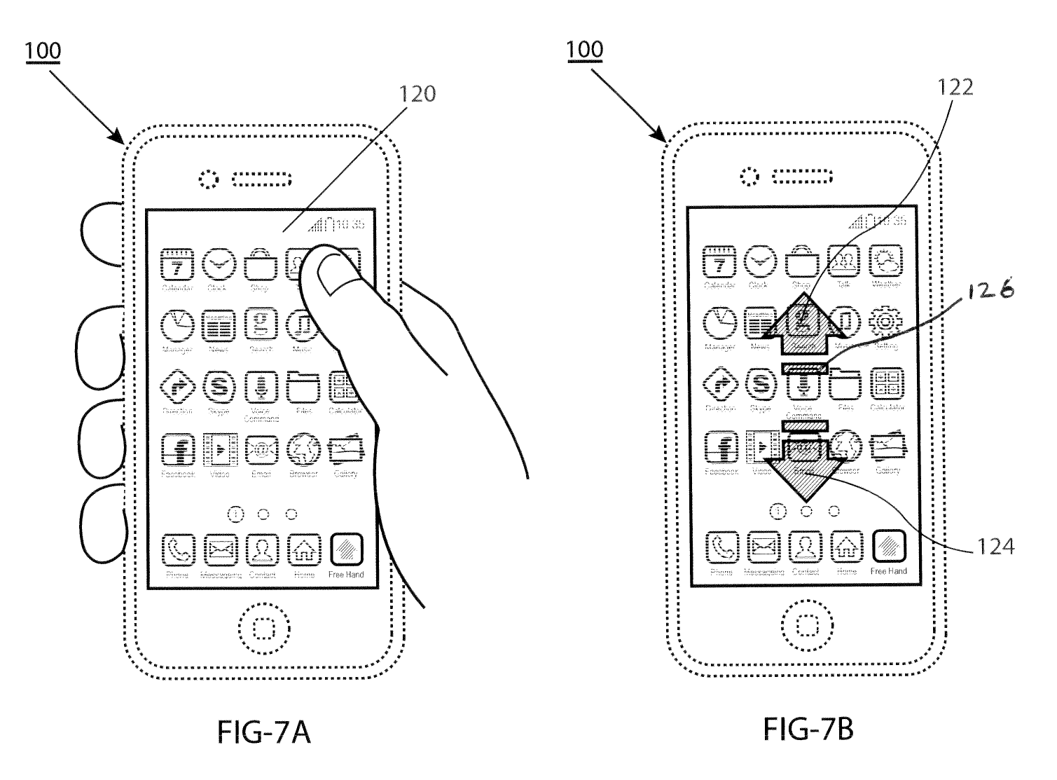

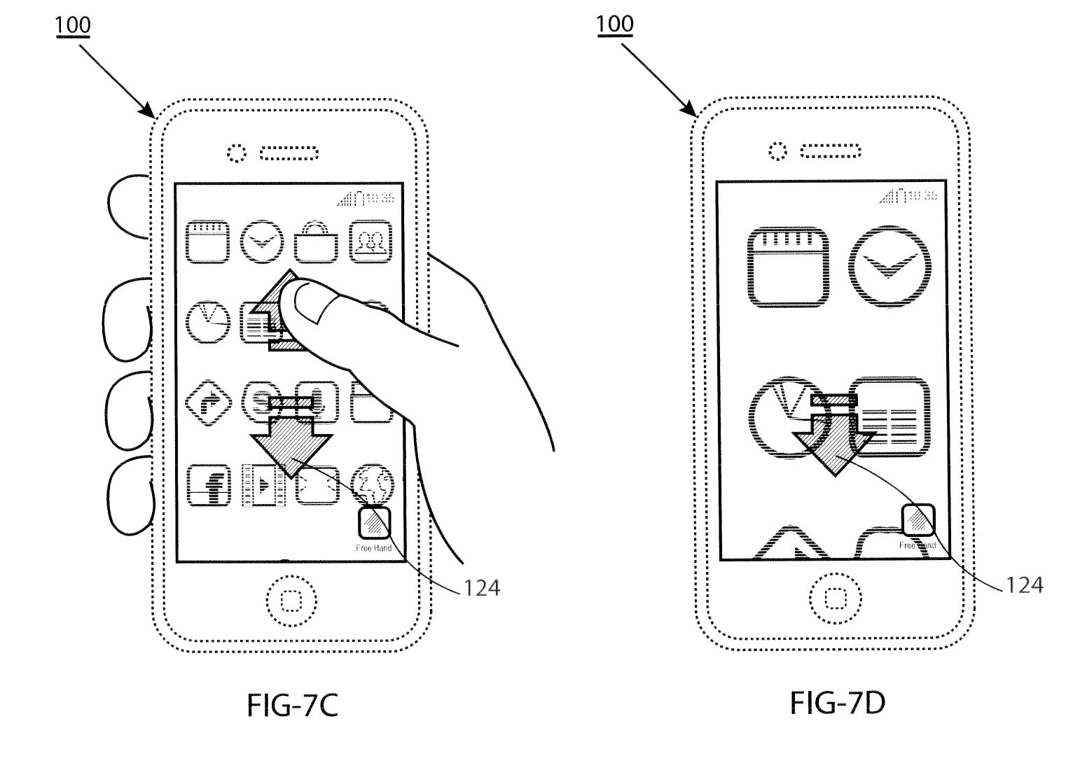

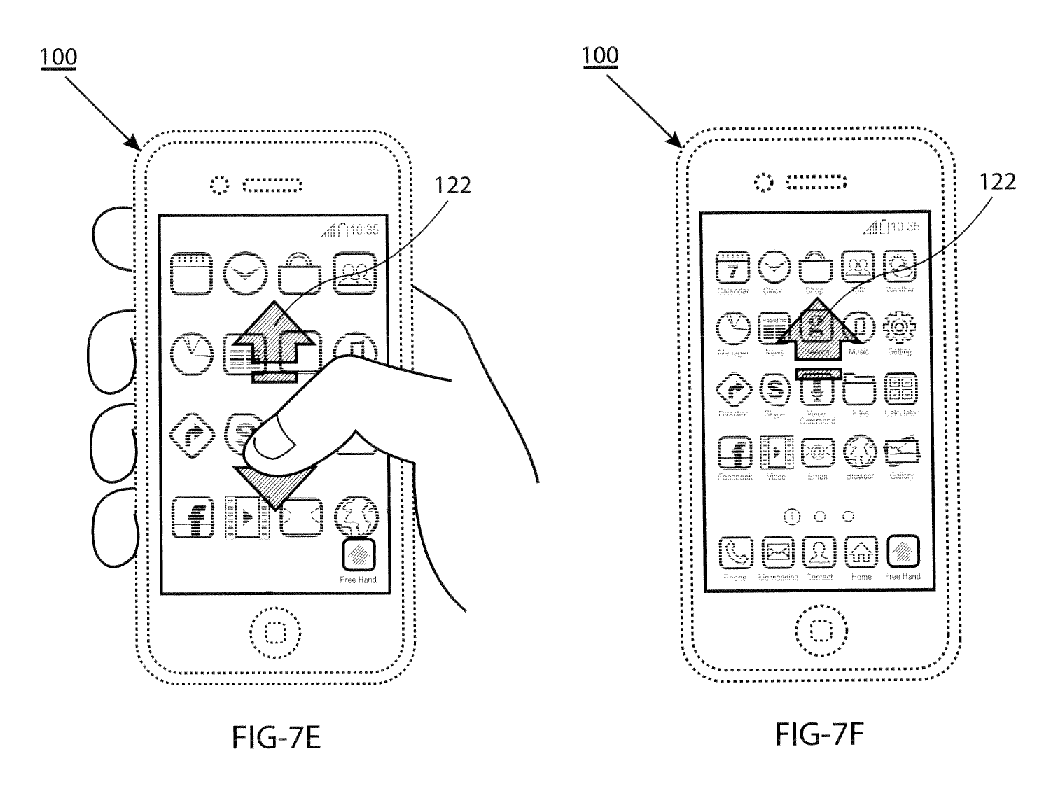

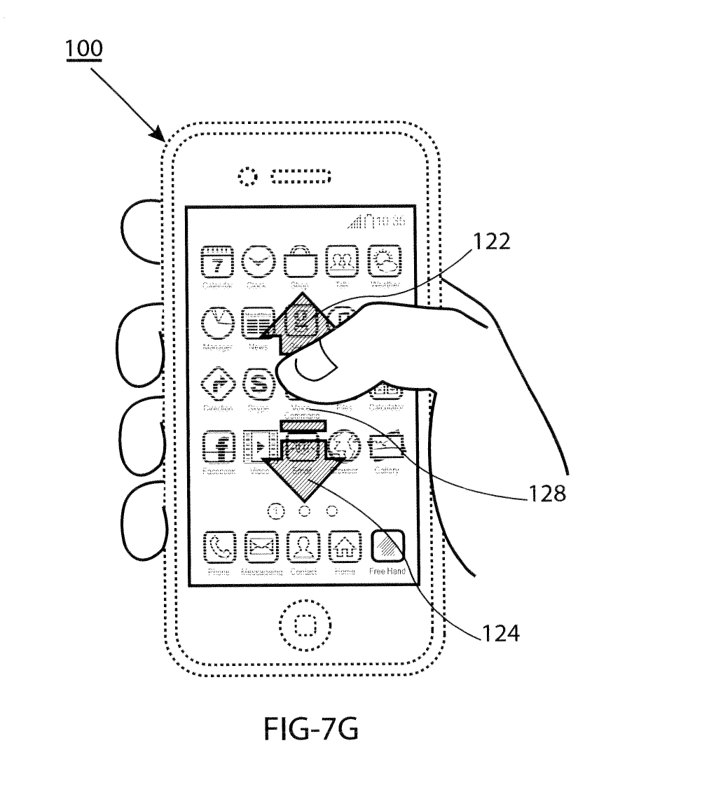

FIGS. 7A-7G illustrate yet another embodiment for controlling one or more parameters in an application, such as adjusting the size of icons for a portable electronic device. The control arrow arrangement 112 of FIGS. 1A-1G is provided on a separate translucent layer from the underlying layer 120.

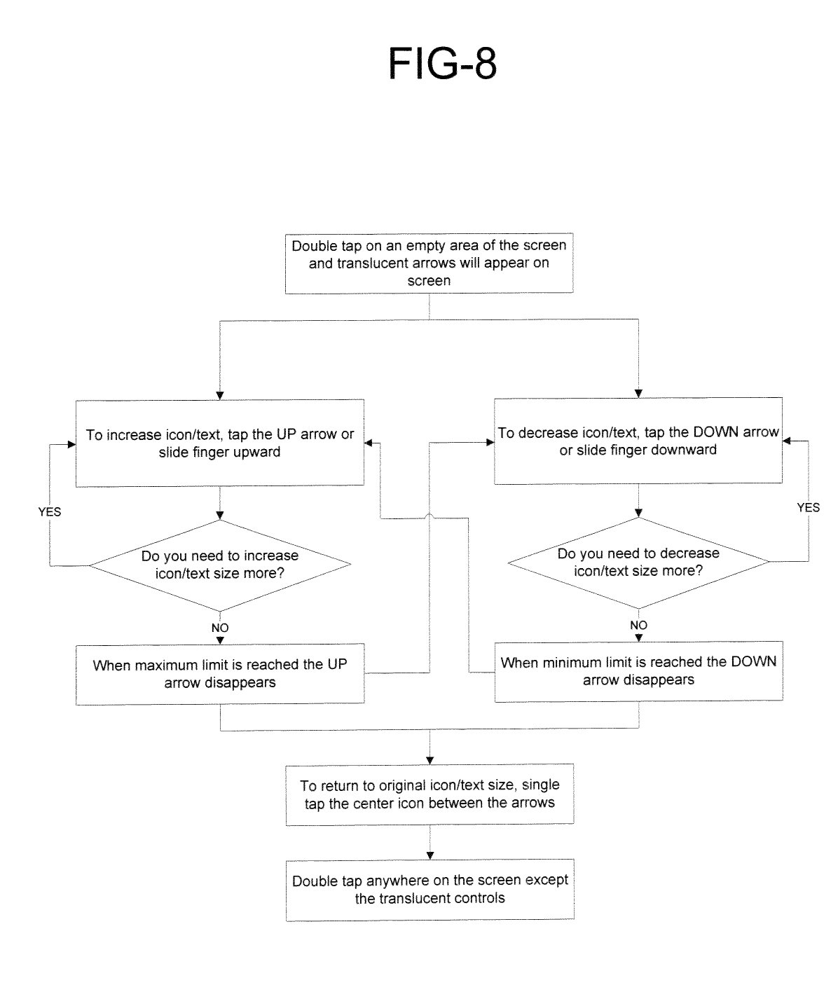

In FIG. 7A, the user is shown as operating the portable electronic device 100 with the primary display for the GUI 102. In FIG. 7A, the user is free to manipulate any of the icons and graphical objects on the primary display. When the user wishes to adjust the size of the icons, the user taps an empty area of the display twice, and the translucent layer will appear (see FIG. 7B), with the arrow arrangement 112 positioned in the middle of the screen. To increase the size, the user taps on the up arrow 122, or slides a finger (e.g., thumb) upwardly (see FIG. 7C). When the maximum size is reached, the up arrow 122 disappears from the translucent layer (see FIG. 7D). Similarly, to decrease the size, the user taps on the down arrow 124, or slides a finger (e.g., thumb) downwardly (see FIG. 7E). When the minimum size is reached, the down arrow 124 disappears from the translucent layer (see FIG. 7F). To bring the size back to the original setting, the user taps on the space 128 between the bars 126 (see FIG. 7G). Finally, to return to the primary display for the GUI 102, the user taps twice on an empty area of the translucent layer, or taps on the free-hand icon 118. This process (using the double-tap method) is illustrated in the flow chart of FIG. 8. The same process can be used to adjust the size of text that is being displayed on the GUI 102.

Change of Mode

In FIGS. 1-9, the control of various parameters in different modes (e.g., volume, image size, brightness, etc.) was described. The GUI 102 of the present invention also allows for the modes to be changed, as shown and described in FIGS. 10A-10F. Starting with FIG. 10A, the GUI 102 is shown in use during normal operation. The user can tap on the free-hand icon 118, or double-tap anywhere on an empty location on the display, to bring out the translucent layer and its control arrow arrangement 112 (see FIG. 10B), as described above. At this point, the control arrow arrangement 112 would be operating in the mode (e.g., volume, brightness, image size, etc.) that was previously adjusted. If the user wishes to change the mode (e.g., from volume to brightness), the user merely presses and holds on the space 128 (see FIG. 10C) until a mode box 142 appears. As shown in FIG. 10D, the mode box 142 includes a selection of all the different modes, and the user the desired mode. In this example, the user selects the “brightness” mode, which converts the control arrow arrangement 112 to operate in the brightness mode (see FIG. 10E). After adjusting the brightness (see FIGS. 3-4), the user can then tap on the free-hand icon 118, or double-tap anywhere on an empty location on the display, to cause the translucent layer to disappear, and to re-active the primary active layer (see FIG. 10F).

Move Arrows or Free-Hand Icon

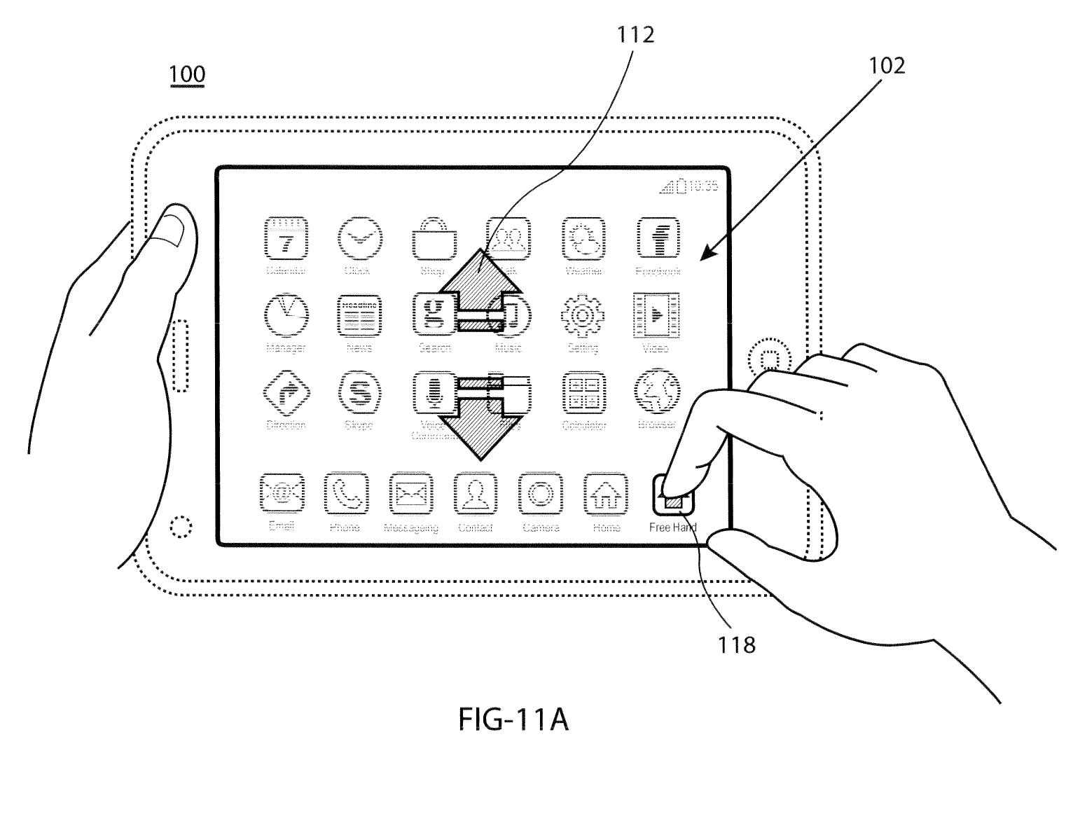

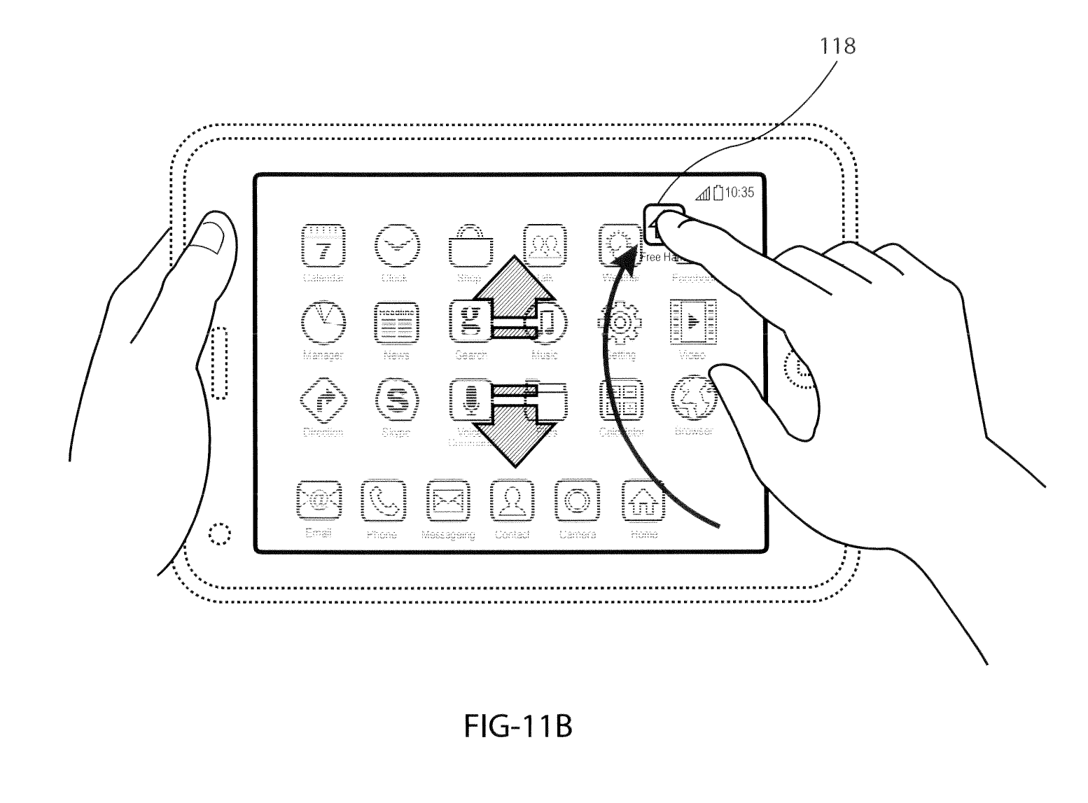

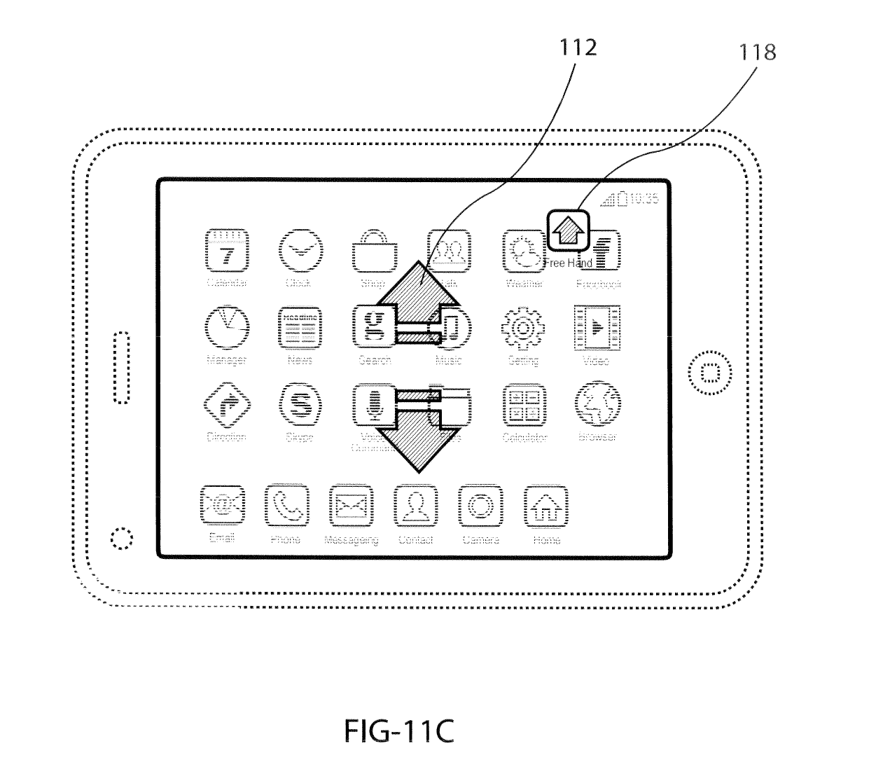

It is also possible to move the location of the control arrow arrangement 112 and the free-hand icon 118. Referring to FIGS. 11A-11C, the portable electronic device 100 is now a tablet. To move the free-hand icon 118 from the bottom right corner of the display, the user merely presses and holds on the free-hand icon 118 until it glows or flashes (see FIG. 11A). The user then drags the free-hand icon 118 to the desired new location (see FIG. 11B), and then releases the finger from the free-hand icon 118. The free-hand icon 118 will then stay in the new location (see FIG. 11C) until moved again.

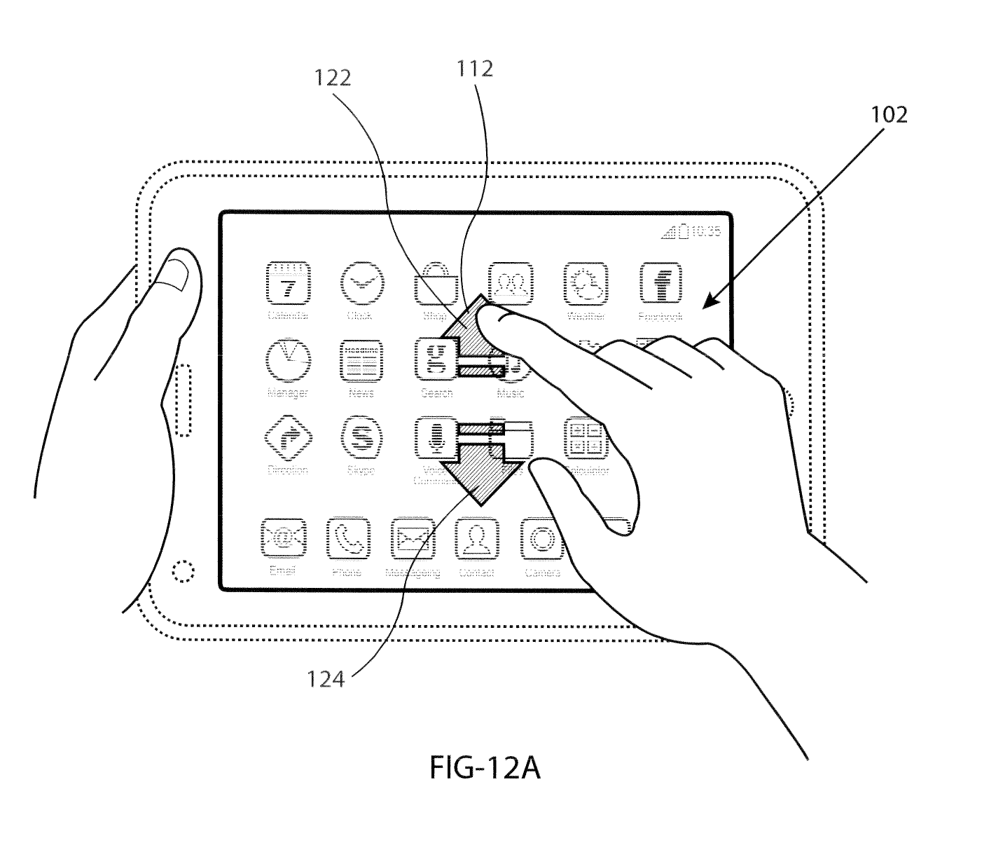

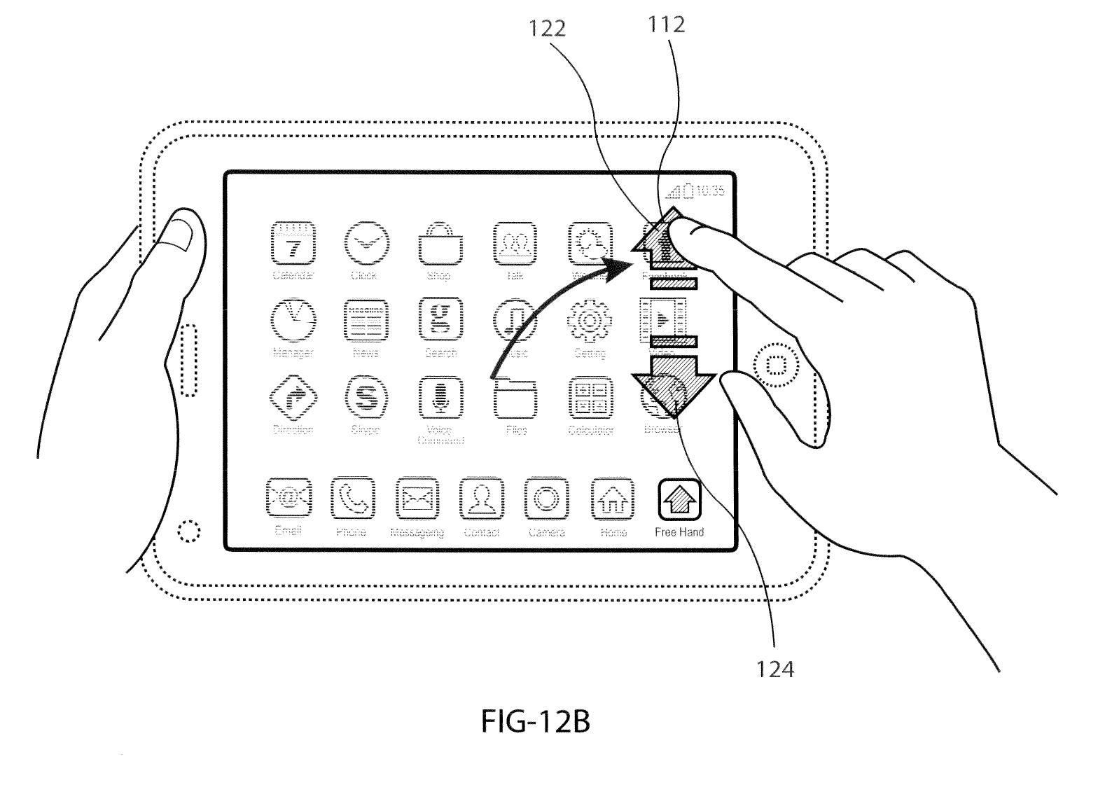

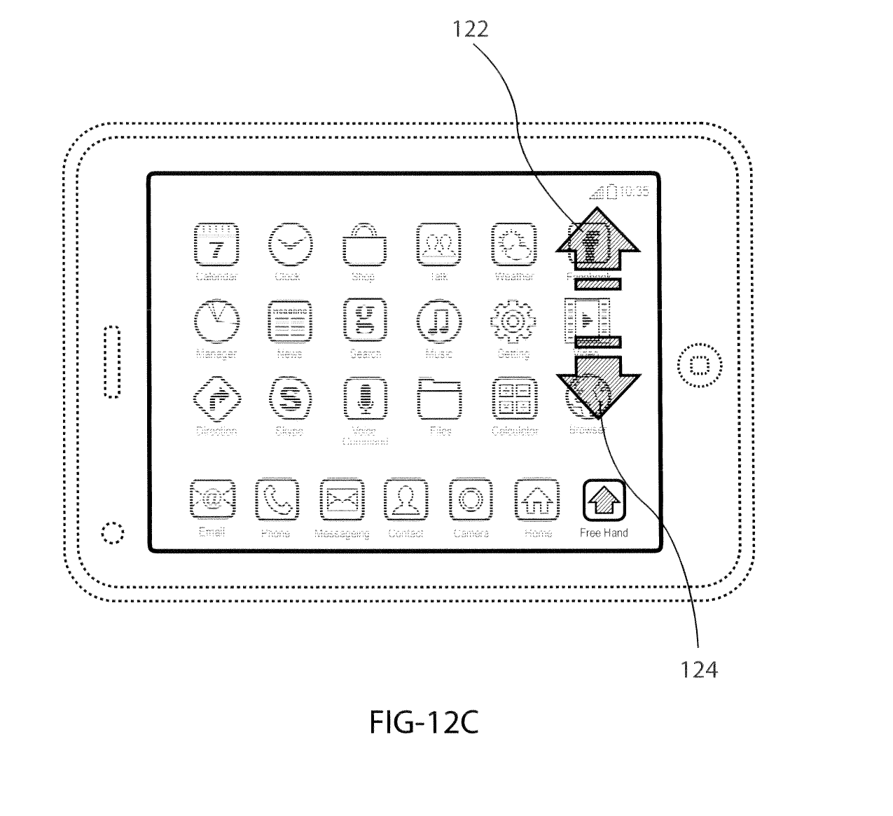

Similarly, to move the control arrow arrangement 112 from the center of the display, the user merely presses and holds on either arrow 122 or 124 of the control arrow arrangement 112 until it glows or flashes (see FIG. 12A). The user then drags the arrow 122 or 124 to the desired new location (see FIG. 12B), and then releases the finger from the arrow 122 or 124. The control arrow arrangement 112 will then stay in the new location (see FIG. 12C) until moved again.

Portable Electronic Device Architecture

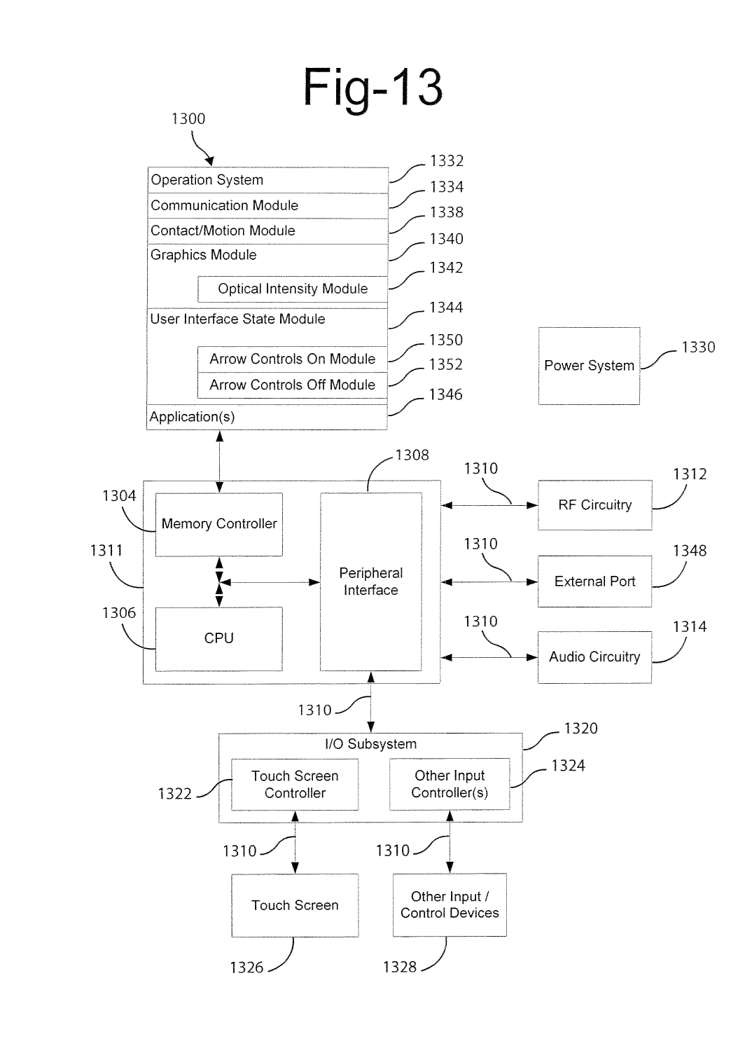

FIG. 13 illustrates the architecture of a portable electronic device 100 that can be used in the present invention. The portable electronic device includes a memory 1300, a memory controller 1304, one or more processing units (CPU's) 1306, a peripherals interface 1308, RF circuitry 1312, audio circuitry 1314 (that includes a speaker and a microphone), an input/output (I/O) subsystem 1320, a touch screen 1326, other input or control devices 1328, and an external port 1348. These components communicate over the one or more communication buses or signal lines 1310. The device 100 can be any portable electronic device, including but not limited to a handheld computer, a tablet computer, a mobile phone, a media player, a personal digital assistant (PDA), or the like, including a combination of two or more of these items. It should be appreciated that the device 100 is only one example of a portable electronic device, and that the device 100 may have more or fewer components than shown, or a different configuration of components. The various components shown in FIG. 13 may be implemented in hardware, software, or a combination of both hardware and software, including one or more signal processing and/or application specific integrated circuits.

The memory 1300 may include high speed random access memory and may also include non-volatile memory, such as one or more magnetic disk storage devices, flash memory devices, or other non-volatile solid state memory devices. In some embodiments, the memory 1300 may further include storage remotely located from the one or more processors 1306, for instance network attached storage accessed via the RF circuitry 1312 or external port 1348 and a communications network (not shown) such as the Internet, intranet(s), Local Area Networks (LANs), Wide Local Area Networks (WLANs), Storage Area Networks (SANs) and the like, or any suitable combination thereof. Access to the memory 1302 by other components of the device, such as the CPU 1306 and the peripherals interface 1308, may be controlled by the memory controller 1304.

The peripherals interface 1308 couples the input and output peripherals of the device to the CPU 1306 and the memory 1302. The one or more processors 1306 run various software programs and/or sets of instructions stored in the memory 1302 to perform various functions for the device and to process data.

In some embodiments, the peripherals interface 1308, the processor(s) 1306, and the memory controller 1304 may be implemented on a single chip, such as a chip 1311. In some other embodiments, they may be implemented on separate chips.

The RF (radio frequency) circuitry 1312 receives and sends electromagnetic waves. The RF circuitry 1312 converts electrical signals to/from electromagnetic waves and communicates with communications networks and other communications devices via the electromagnetic waves. The RF circuitry 1312 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 1312 may communicate with the networks, such as the Internet, also referred to as the World Wide Web (WWW), an Intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11 n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry 1314 (and its speaker and microphone) provide an audio interface between a user and the device. The audio circuitry 1314 receives audio data from the peripherals interface 1308, converts the audio data to an electrical signal, and transmits the electrical signal to the speaker. The speaker converts the electrical signal to human-audible sound waves. The audio circuitry 1314 also receives electrical signals converted by the microphone from sound waves. The audio circuitry 1314 converts the electrical signal to audio data and transmits the audio data to the peripherals interface 1308 for processing. Audio data may be retrieved from and/or transmitted to the memory 1302 and/or the RF circuitry 1312 by the peripherals interface 1308. In some embodiments, the audio circuitry 1314 also includes a headset jack (not shown). The headset jack provides an interface between the audio circuitry 1314 and removable audio input/output peripherals, such as output-only headphones or a headset with both output (headphone for one or both ears) and input (microphone).

The I/O subsystem 1320 provides the interface between input/output peripherals on the device 100, such as the touch screen 1326 and other input/control devices 1328, and the peripherals interface 1308. The I/O subsystem 1320 includes a touch-screen controller 1322 and one or more input controllers 1324 for other input or control devices. The one or more input controllers 1324 receive/send electrical signals from/to other input or control devices 1328. The other input/control devices 1328 may include physical buttons (e.g., push buttons, rocker buttons, etc.), dials, slider switches, sticks, and so forth.

The touch screen 1326 provides both an output interface and an input interface between the device 100 and a user. The touch-screen controller 1322 receives/sends electrical signals from/to the touch screen 1326. The touch screen 1326 displays visual output to the user. The visual output may include text, graphics, video, and any combination thereof. Some or all of the visual output may correspond to user-interface objects, further details of which are described below.

The touch screen 1326 also accepts input from the user based on haptic and/or tactile contact. The touch screen 1326 forms a touch-sensitive surface that accepts user input. The touch screen 1326 and the touch screen controller 1322 (along with any associated modules and/or sets of instructions in the memory 1302) detects contact (and any movement or break of the contact) on the touch screen 1326 and converts the detected contact into interaction with user-interface objects, such as one or more soft keys, that are displayed on the touch screen. In an exemplary embodiment, a point of contact between the touch screen 1326 and the user corresponds to one or more digits of the user. The touch screen 1326 may use LCD (liquid crystal display) technology, or LPD (light emitting polymer display) technology, although other display technologies may be used in other embodiments. The touch screen 1326 and touch screen controller 1322 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 1326. The touch-sensitive display may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference. However, the touch screen 1326 displays visual output from the portable device 100, whereas touch sensitive tablets do not provide visual output. The touch screen 1326 may have a resolution in excess of 100 dpi. In an exemplary embodiment, the touch screen 1326 may have a resolution of approximately 168 dpi. The user may make contact with the touch screen 1326 using any suitable object or appendage, such as a stylus, finger, and so forth.

In some embodiments, in addition to the touch screen 1326, the device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 1326 or an extension of the touch-sensitive surface formed by the touch screen 1326.

The device 100 also includes a power system 1330 for powering the various components. The power system 1330 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

In some embodiments, the software components include an operating system 1332, a communication module (or set of instructions) 1334, a contact/motion module (or set of instructions) 1338, a graphics module (or set of instructions) 1340, a user interface state module (or set of instructions) 1344, and one or more applications (or set of instructions) 1346.

The operating system 1332 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 1334 facilitates communication with other devices over one or more external ports 1348 and also includes various software components for handling data received by the RF circuitry 1312 and/or the external port 1348. The external port 1348 (e.g., Universal Serial Bus (USB), FIREWIRE, etc.) is adapted for coupling directly to other devices or indirectly over a network (e.g., the Internet, wireless LAN, etc.).

The contact/motion module 1338 detects contact with the touch screen 1326, in conjunction with the touch-screen controller 1322. The contact/motion module 1338 includes various software components for performing various operations related to detection of contact with the touch screen 1322, such as determining if contact has occurred, determining if there is movement of the contact and tracking the movement across the touch screen 1326, and determining if the contact has been broken (i.e., if the contact has ceased). Determining movement of the point of contact may include determining speed (magnitude), velocity (magnitude and direction), and/or an acceleration (including magnitude and/or direction) of the point of contact. In some embodiments, the contact/motion module 1326 and the touch screen controller 1322 also detects contact on the touchpad.

The graphics module 1340 includes various known software components for rendering and displaying graphics on the touch screen 1326. Note that the term “graphics” includes any object that can be displayed to a user, including without limitation text, web pages, icons (such as user-interface objects including soft keys), digital images, videos, animations and the like. In some embodiments, the graphics module 1340 includes an optical intensity module 1342. The optical intensity module 1342 controls the optical intensity of graphical objects, such as user-interface objects, displayed on the touch screen 1326. Controlling the optical intensity may include increasing or decreasing the optical intensity of a graphical object. In some embodiments, the increase or decrease may follow predefined functions.

The user interface state module 1344 controls the user interface state of the device 100. The user interface state module 1344 may include an arrows control “on” lock module 1350 and an arrows control “off” module 1352. The arrows control “on” module 1350 detects satisfaction of any of one or more conditions to cause the translucent layer and the control arrow arrangement 112 to appear. The arrows control “off” module 1352 detects satisfaction of any of one or more conditions to cause the primary layer to appear, and the translucent layer and the control arrow arrangement 112 to disappear. The operation of these modules 1350 and 1352 are described hereinabove in connection with FIG. 9. In some embodiments, a gesture such as a double tap in an unused area of the touch screen will activate or deactivate the arrows control “on” module 1350 and the arrows control “off” module 1352. When activated, the arrow control “on” module 1350 allows the interface to control various hardware components such as audio, graphics and others, and the translucent layer takes control of the primary layer below by changing graphical size, brightness and contrast. The translucent layer can also be controlled, allowing the arrows and other interfaces to be moved on the translucent layer without affecting the primary layer.

The one or more applications 1346 can include any applications installed on the device 100, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player (which plays back recorded music stored in one or more files, such as MP3 or AAC files), etc.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A method of controlling an electronic device with a touch-sensitive display that has a graphical user interface (GUI) with a primary display and a translucent layer, the method comprising:
displaying the primary display which contains the graphical objects for normal operation;
while the primary display is being displayed, activating the translucent layer to display a control arrow arrangement;
manipulating the control arrow arrangement to adjust a parameter associated with the GUI or the electronic device; and
de-activating the translucent layer to cause the primary display to be displayed again.

2. The method claim 1, wherein step of activating the translucent layer comprises double-tapping an unused area of the primary display.

3. The method claim 1, wherein step of activating the translucent layer comprises pressing on an activation icon positioned on the primary display.

4. The method of claim 1, wherein the control arrow arrangement comprises an up arrow, a down arrow and an empty space between the up arrow and the down arrow.

5. The method of claim 4, wherein the step of manipulating the control arrow arrangement comprises pressing on either the up arrow or the down arrow.

6. The method of claim 4, wherein the step of manipulating the control arrow arrangement comprises sliding a finger along either the up arrow or the down arrow.

7. The method of claim 1, wherein the parameter is selected from the group consisting of sound volume, brightness, and size of image, icon or text.

8. The method claim 1, wherein step of de-activating the translucent layer comprises double-tapping an unused area of the primary display.

9. The method claim 1, wherein step of de-activating the translucent layer comprises pressing on an activation icon positioned on the translucent layer.

10. The method of claim 4, further including the step of:
changing the parameter to be adjusted.

11. The method of claim 10, wherein the step of changing the parameter to be adjusted comprises:
pressing and holding on the empty space between the up arrow and the down arrow until a mode box appears with the parameters to be selected; and
selecting the parameter to be adjusted.

12. The method of claim 4, further including the step of:
moving the location of the control arrow arrangement.

13. A portable electronic device, comprising: a touch-sensitive display that has a graphical user interface (GUI) with a primary display and a translucent layer; a memory; one or more processors; and one or more modules stored in the memory and configured for execution by the one or more processors, the one or more modules including instructions:
to display the primary display which contains the graphical objects for normal operation;
while the primary display is being displayed, to activate the translucent layer to display a control arrow arrangement;
to manipulate the control arrow arrangement to adjust a parameter associated with the GUI or the electronic device; and
to de-activate the translucent layer to cause the primary display to be displayed again.
